(19) United States
(12) Patent Application Publication
(10) Pub. No.: US 2015/0122608 A1
(43) Pub. Date: May 7, 2015

(54) PISTON FOR A CLUTCH BRAKE ASSEMBLY

(71) Applicant: Eaton Corporation, Cleveland, OH (US)

(72) Inventor: Fang Du, Medina, OH (US)

(21) Appl. No.: 14/073,932

(22) Filed: Nov. 7, 2013

(51) Int. Cl. F16D 13/40; F16D 13/64

(52) U.S. Cl. CPC F16D 13/40; F16D 13/64
USPC 192/66.3; 192/107 R

(57) ABSTRACT

A clutch-brake assembly transmits force to rotate a shaft and to retain the shaft against rotation. The assembly includes a plurality of force transmitting members which transmit force between an improved piston and a base member. A plurality of springs urge the piston to move relative to the base member. A plurality of spring retainers are disposed between the base member and the piston. Each of the spring retainers includes a plurality of projecting portions extending from the base portion. Each of the springs is telescopically disposed on one of the projecting portions. Each of the force transmitting members is disposed between adjacent spring retainers. The improved piston includes a cast light weight body securing at least one wear plate made from a wear resistant material with wear surfaces exposed on an outer flange of the cast body.

### BACKGROUND OF THE DISCLOSURE

The present disclosure relates in general to an improved clutch brake assembly and in particular to an improved piston for a clutch-brake assembly which is utilized to transmit force to rotate a shaft and to transmit force to retain the shaft against rotation.

Clutch-brake assemblies connected with a shaft control power transmission. Clutch-brake assemblies have been utilized in association with can-making machines, press drives, and shear drives, as well as other machines. Some of these clutch-brake assemblies are disclosed in U.S. Pat. Nos. 5,046,593; 5,257,684; 5,577,581; 6,637,568; 7,604,104; and 8,245,827.

The force transmitting capability of a clutch-brake assembly must correspond to the operating characteristics of the machine they are operating. Thus, one machine may require the transmission of relatively large forces to rotate a shaft and to retain the shaft against rotation while another machine may require smaller forces to rotate the shaft and retain the shaft against rotation.

An important feature for a clutch brake assembly is the time it takes to provide a stop to the rotation, that is, a faster stop. This is important for both safety reasons and efficient operating reasons. Similarly another important feature is achieving the smallest stopping angle possible with the clutch brake assembly. It is desirable to continuously make improvements to a clutch brake assembly that can achieve a faster stop and smaller stop angle for the above reasons as well as others.

The improved piston of the present disclosure provides such an improvement to a clutch brake assembly by providing a piston that weighs less than a current ductile iron piston and still has wear plates with a suitable life span that can provide a faster stop and a smaller stop angle.

### SUMMARY OF THE DISCLOSURE

The present disclosure relates to an improved clutch-brake assembly that allows for a faster stop and smaller stop angle.

The present disclosure also relates to an improved piston for a clutch brake assembly that is lighter in weight yet includes a strong wear plate with suitable life expectancy.

The improved piston for use in a clutch brake assembly includes an annular wear plate made from a first selected material having wear resistance. The annular wear plate includes a circular central opening therethrough. The annular wear plate has a wear surface defined by an outer area between an inner circumference of the first annular wear plate around the circular central opening extending to an outer circumference of the first annular wear plate. A plurality of supports are disposed on the annular wear plate. A body of a second light weight material is formed around the plurality of supports and secures the annular wear plate. The body includes a circular central opening smaller in diameter than the circular central opening of the annular wear plate. The body further includes an annular flange containing the wear surface of the annular wear plate.

The clutch-brake assembly may include a base member having a central opening which receives a shaft. A clutch disc may be movable relative to the base member. A brake disc may be axially movable relative to the base member. A piston may be movable in one direction relative to the base member to press an annular flange against the clutch disc to enable force to be transmitted from the friction surface on the clutch disc. The piston may be movable in the other direction to press against a friction surface on the brake disc for braking.

### BRIEF DESCRIPTION OF THE DRAWINGS

The foregoing and other features of the disclosure will become more apparent upon a consideration of the following description taken in connection with the accompanying drawings wherein:

FIG. 1 is a simplified schematic illustration depicting the manner in which a clutch-brake assembly constructed in accordance with the present invention may be mounted to transmit force to rotate a shaft and to transmit force to retain the shaft against rotation;

FIGS. 2A and 2B are an exploded schematic pictorial illustration depicting the construction of the clutch-brake assembly of FIG. 1;

FIG. 3 is a sectional view of the clutch-brake assembly depicted in FIG. 1;

FIG. 4 depicts the wear plate and arrangement of the supports prior to being formed into the improved piston;

FIG. 5 is an elevated view of the improved piston according to the present disclosure; and

FIG. 6 is a view similar to FIG. 5 with a portion of the improved piston removed.

### DETAILED DESCRIPTION OF THE DISCLOSURE

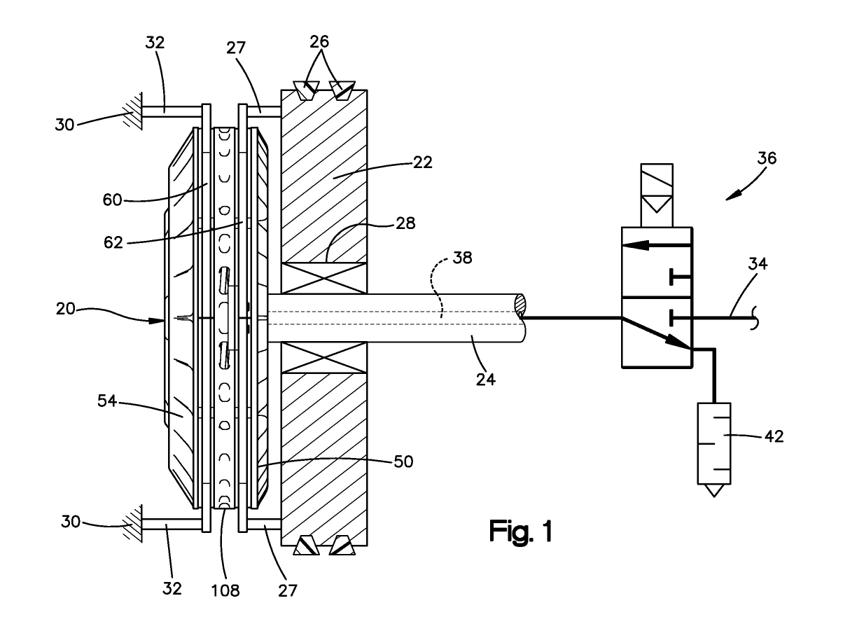

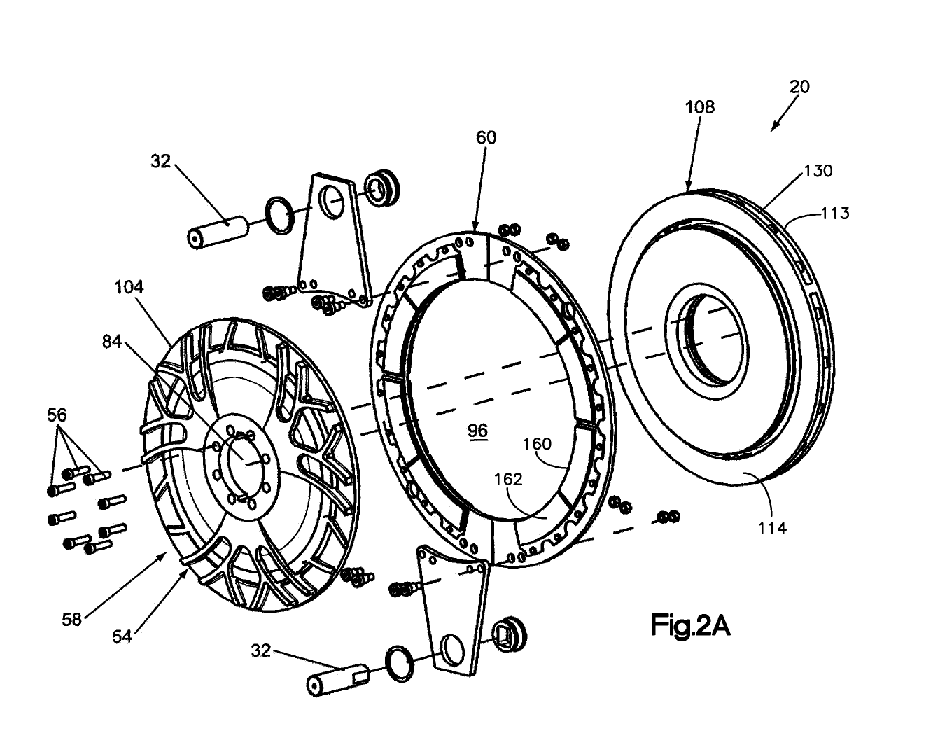

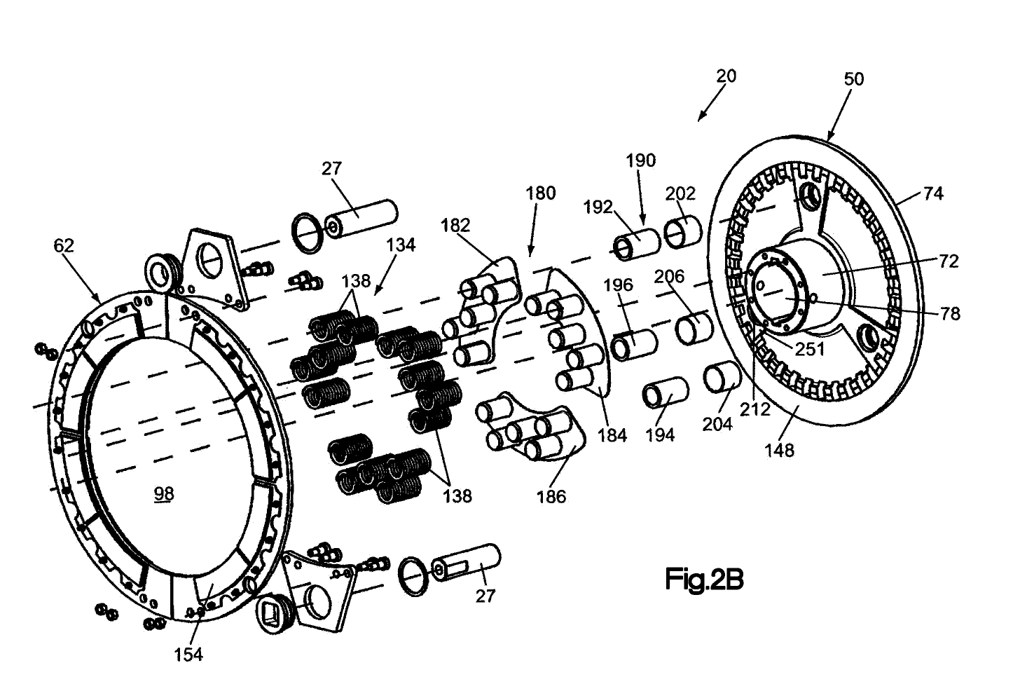

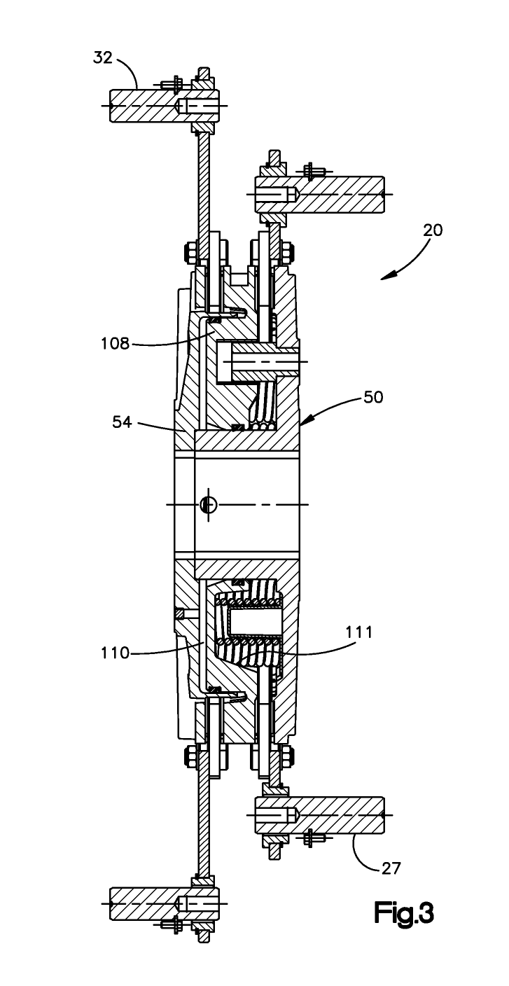

A clutch-brake assembly 20 (FIGS. 1, 2A and 2B) is operable between an engaged condition and a disengaged condition. When the clutch-brake assembly 20 is in the engaged condition, the clutch-brake assembly is effective to transmit force from a drive member 22 (FIG. 1) to a driven member 24. When the clutch-brake assembly 20 is in the disengaged condition, the clutch-brake assembly is effective to hold the driven member 24 against rotation.

The illustrated drive member 22 (FIG. 1) is a circular flywheel which is driven by belts 26 which extend around the periphery of the flywheel. The drive member 22 is connected with the clutch-brake assembly 20 by connector members 27. The illustrated driven member 24 is a metal shaft which is rotated about its longitudinal central axis under the influence of force transmitted from the flywheel 22 through the clutch-brake assembly 20 to the shaft.

The shaft 24 and flywheel 22 may be mounted on bearings 28 (FIG. 1) for rotation relative to each other. However, the flywheel 22 and shaft 24 may be mounted in a different manner if desired. It should be understood that the flywheel 22 and shaft 24 are representative of many different known drive and driven members.

When the clutch-brake assembly 20 is in the disengaged condition, the clutch-brake assembly transmits force from a stationary member or frame 30 to hold the shaft 24 against rotation. The stationary frame 30 may be any desired structure which is stationary. The stationary frame 30 is connected with the clutch-brake assembly 20 by connector members 32. The disengaged the clutch-brake assembly 20 interconnects the stationary frame 30 and the shaft 24 so that the shaft does not rotate.

The clutch-brake assembly 20 is operated to the engaged condition by fluid pressure, typically, air. The fluid pressure is conducted from a source or conduit 34, through a solenoid operated valve 36 to a central passage 38 in the shaft 24. The clutch-brake assembly 20 is connected in fluid communication with the central passage 30 in the shaft 24.

When the valve 36 is in the unactuated condition illustrated schematically in FIG. 1, the passage 38 in the shaft 24 and the clutch-brake assembly 20 are exhausted to atmosphere through a muffler 42. At this time, the disengaged clutch-brake assembly 20 connects the shaft 24 with the stationary frame 30 to hold the shaft against rotation.

Upon actuation of the valve 36, the source conduit 34 is connected in fluid communication with the passage 38. Fluid pressure conducted through the shaft 38 to the clutch-brake assembly 20 actuates the clutch-brake assembly to the engaged condition. When the clutch-brake assembly 20 is in the engaged condition, force is transmitted from the flywheel 22 through the clutch-brake assembly 20 to the shaft 24 to rotate the shaft about its longitudinal central axis. It is contemplated that the shaft 24 may be connected with many different types of equipment. For example, the clutch-brake assembly 20 may be utilized to transmit power to a can-forming machine.

Although the clutch-brake assembly 20 may be associated with can-forming machines, it is contemplated that the clutch-brake assembly will be utilized in association with other known machines requiring acceleration and deceleration of components of the machine and relatively high disengaging and engaging frequencies. The machines with which the clutch-brake assembly 20 is associated may, for example, be a press and/or shear drive. The machines may be single stroke or continuous-running machines. For example, the clutch-brake assembly 20 may be associated with metal stamping machines, wire processing machines, thread rolling machines, veneer-cutting machines, bottle sorting machines, paper processing machines or textile machines. Of course, it should be understood that the clutch-brake assembly 20 may be associated with other types of machines if desired.

The clutch-brake assembly 20 has the same general construction as the clutch-brake assembly disclosed in U.S. Pat. Nos. 6,637,568; 7,604,104; and 8,245,827 except for the improved piston which will be described in much greater detail later herein. The disclosure in the aforementioned U.S. Pat. Nos. 6,637,568; 7,604,104; and 8,245,827 are hereby incorporated herein in their entirety by this reference thereto.

To better understand the structure and operation of the improved piston of the present disclosure and its advantages, the clutch brake assembly and its components are described in more detail now. The clutch-brake assembly 20 (FIG. 2) includes a hub or base end member 50 (FIGS. 1 and 2B) and a cylinder or cover member 54 (FIGS. 1 and 2A). The cylinder or cover member 54 and hub or base end member 50 are interconnected by bolts 56 (FIG. 2A) to form a body assembly 58. In addition, the clutch-brake assembly 20 includes a brake disc 60 and a clutch disc 62 (FIG. 2B). The brake disc 60 (FIG. 2A) is connected with the body assembly 58. The brake disc 60 is not rotatable relative to body assembly 58. The clutch disc 62 (FIG. 2B) is also connected with the body assembly 58. The clutch disc 62 is freely rotatable relative to the body assembly 58 when the clutch-brake assembly 20 is in the disengaged condition.

In addition, the brake and clutch discs 60 and 62 (FIGS. 2A and 2B) are axially moveable, through a limited range of movement, relative to the body assembly 58. The brake and clutch disc 60 and 62 have a generally annular configuration. The body assembly 58 extends through circular openings in the central portions of the brake disc 60 and clutch disc 62. Regardless of the orientation in which the clutch-brake assembly 20 is disposed, the brake disc 60 is connected with the stationary frame member 30 by the connector members 32 and the clutch disc 62 is connected with the driving member or flywheel 22 by the connector members 27. The body assembly 58 of the clutch-brake assembly 20 is fixedly connected to the shaft or other driven member 24.

When the clutch-brake assembly 20 is in the engaged condition, the clutch-disc 62 is held against rotation relative to the body assembly 58. At this time, the clutch disc 62 is effective to transmit force from the flywheel 22 to the body assembly 58. This force rotates the body assembly and the shaft 24 about the longitudinal central axis of the shaft. At this time, the body assembly 58 is freely rotatable relative to the brake disc 60.

When the clutch-brake assembly 20 is in the disengaged condition, the body assembly 58 is held against rotation relative to the brake disc 60. This enables force to be transmitted from the stationary frame 30 through the brake disc 60 to the body assembly 58 to hold the body assembly and shaft 24 against rotation. At this time, the flywheel 22 (FIG. 1) and clutch disc 62 (FIG. 2B) are freely rotatable together relative to the body assembly 58 and shaft 24.

The metal body assembly 58 of the clutch-brake assembly 20 includes the metal hub or base member 50. The hub or base member 50 is cast as one piece of metal and includes a generally cylindrical central section 72 (FIG. 2B). A generally annular flange section 74 is integrally formed as one piece with the central section 72 and extends radially outward from the central section. A cylindrical central opening or passage 78 extends through the central section 72 of the hub or base member 50.

The body assembly 58 also includes the circular metal cylinder or cover member 54 (FIG. 2A) which is fixedly connected to the hub or base member 50 (FIG. 2B) by the bolts 56. The cylinder or cover member 54 has a circular opening 84 which is disposed in a coaxial relationship with and forms a continuation of the central opening 78 in the hub or base member 50.

The annular brake disc 60 (FIG. 2A) and annular clutch disc 62 (FIG. 2B) are disposed in a coaxial relationship with the circular hub or base member 50 and the circular cylinder or cover member 54. The brake disc 60 has a circular central opening 96 which is disposed in a coaxial relationship with the circular central opening 78 in the hub or base member 50. Similarly, the clutch disc 62 has a circular central opening 98 which is disposed in a coaxial relationship with the central opening 78 in the hub or base member 50. The central openings 96 and 98 in the brake disc 60 and clutch disc 62 are the same size and are smaller in diameter than the flange section 74 of the hub or base member 50 and circular rim portion 104 of the cylinder or cover member 54. Therefore, the brake disc 60 and clutch disc 62 are connected with the body assembly 58 by being retained between the flange section 74 of the hub or base member 50 and the rim portion 104 of the cylinder or cover member 54.

An annular piston 108 (FIG. 2A) is disposed between the hub or base member 50 and the cylinder or cover member 54. The piston 108 cooperates with the hub or base member 50 and cylinder or cover member 54 to form an annular variable volume fluid chamber 110 and annular variable volume spring chamber 111. Spring chamber 111 is arranged in the piston 108 to receive an end of springs 138. The annular variable fluid chamber 110 is connected in fluid communication with the central opening 78 in the hub or base member 50 and with the shaft 24 by a passage which extends through the central section 72 of the hub or base member 50. The annular spring chamber 111 is continuously connected in fluid communication with atmosphere around the clutch-brake assembly through openings formed in the hub or base end member 50.

The piston 108 is continuously urged toward the cylinder or cover member 54 by a plurality 134 of springs 138 as seen in FIG. 2B. The plurality 134 of springs 138 is disposed in an annular array about and in a coaxial relationship with the cylindrical central portion 72 of the hub or base member 50. The left (as viewed in FIG. 2B) ends of the helical coil springs 138 abut the piston 108 and are disposed in engagement with the piston.

During operation of the clutch-brake assembly 20, fluid, that is, air, under pressure is conducted through the valve 36 (FIG. 1) and through the passage 38 in the shaft 24. The fluid pressure is conducted through an outlet in a cylindrical outer side surface of the shaft 24 through a passage in the hub or base member 50. The fluid pressure is conducted into an annular variable volume fluid chamber 110 formed between the piston 108 and the cylinder or cover member 54.

The fluid pressure in the fluid chamber 110 formed between the piston 108 and the cover member 54 is effective to apply force against the piston 108 and to compress the plurality 134 of springs 138. As this occurs, an annular flange portion 113 of the piston 108 presses an annular friction surface 154 on the clutch disc 62 along with the surface friction 152 on the opposite side of the clutch disc 62 firmly against an annular hub surface 148 on the flange section 74 of the hub or base member 50.

This results in force, that is, torque being transmitted from the flywheel 22 (FIG. 1) through the clutch disc 62 (FIG. 2) to the hub or base member 50. The hub or base member 50 is connected with the shaft 24. Torque transmitted from the flywheel 22 through the clutch disc 62 and hub or base member 50 to the shaft 24 is effective to rotate the shaft about its longitudinal central axis.

When the clutch-brake assembly 20 is to be disengaged, the variable volume fluid chamber 110 between the piston 108 and the cylinder or cover member 54 is vented to atmosphere through a passage in the hub or base member, the passage 38 in the shaft 24 (FIG. 1), and the valve 36. This results in the plurality 134 of springs 138 expanding and being effective to press the annular flange portion 114 of the piston 108 against the friction surface 160 of annular brake disc 60. The annular friction surface 162 on the brake disc 60 is pressed against an annular cylinder surface on the rim portion 104 of the cylinder or cover member 58. This results in force being transmitted between the stationary frame or member 30 (FIG. 1) and the shaft 24 through the brake disc 60 and hub or base member 50. The force transmitted through the brake disc 60 is effective to hold the shaft 24 against rotation.

A plurality 180 of spring retainers 182, 184 and 186 (FIG. 2B) are disposed in a circular array between the hub or base member 50 and the piston 108. The helical coil springs 138 and the plurality 134 of springs are positioned relative to the hub or base member 50 and the piston 108 by the plurality of the spring retainers 182, 184, and 186. A plurality 190 of force transmitting members 192, 194, and 196 extend between the hub or base member 50 and the piston 108. The hollow cylindrical force transmitting members or tubes 192, 194, and 196 are slidably received in hollow cylindrical bushings 202, 204, and 206. The bushings 202, 204, and 206 may be fixedly secured in the cylindrical chambers 172 in the piston 108. The force transmitting members 192, 194, and 196 interconnect the hub or base member 50 and the piston 108.

The general construction and mode of operation of the clutch-brake assembly 20 is similar to the construction and mode of operation of clutch-brake assemblies disclosed in the aforementioned U.S. Patents incorporated herein by reference except for the structure and function of the improved piston 108 which is described in much greater detail as follows.

The piston 108 in accordance with a first embodiment of the present disclosure is a cast body assembly, preferably made from a light weight material, like an aluminum or an aluminum alloy, alternatively other light weight metal or nonmetal material or metal alloy may be used. The cast piston 108 may include at least one wear plate 112 and more preferably two wear plates 112, one on each side of the annular flange portions 113, 114 of the piston 108. The wear plates 112 may even be or make up the entire flange portion 113, 114. Piston 108 has an annular shape with a circular central opening constructed to align with opening 78 in the hub or base member 50. As will be explained in greater detail later herein, the wear plates 112 is disposed in the piston 108 so that its outer surfaces on flange portions 113, 114 are exposed during the casting process and functions as the wear surfaces on the annular flanges 113, 114 of the piston 108.

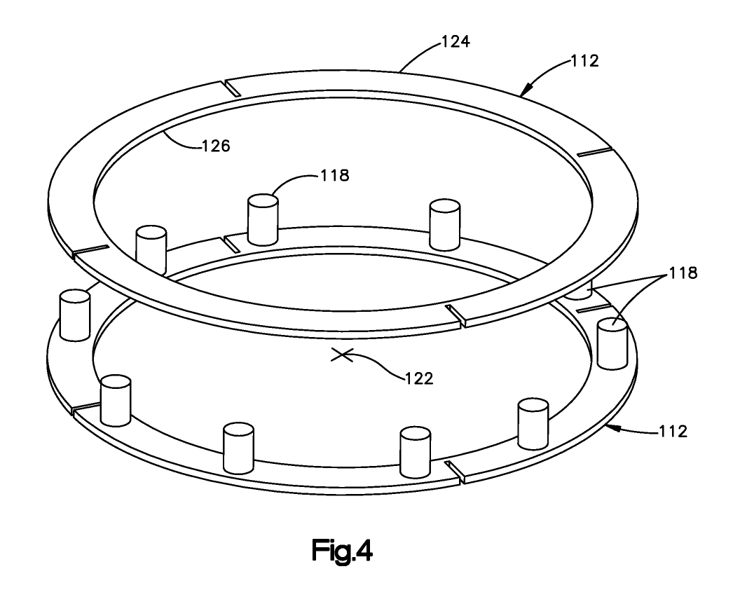

A plurality of metal supports 118 in one embodiment in the form of multiple pillars as best seen in FIG. 4 may be positioned between the two wear plates 112 in an arrangement that places one wear plate 112 concentrically over the other with the supports 118 arranged in between them. The supports 118 are arranged circumferentially around the inner surface 120 of each of the annular wear plates 112. The annular wear plate 112 includes a circular central opening 122 sized in a manner to locate the surface of the wear plate 112 as the outer surface, one for the the annular flange 113 and the other for annular flange 114. The outer surface of one wear plate 112 is exposed during the casting process for engaging the brake disc 60 on one side of the piston 108 and on the opposite side of the piston the other outer surface of the other wear plate 112 is exposed for engaging the clutch disc 62. This wear surface area of the wear plates 112 may be further defined as being the area on an outer side of the wear plate 112 between the outer circumference 124 of wear plate 112 and the inner circumference 126. Wear plate 112 can have a shape of a planar ring. In an alternate embodiment there may be only one wear plate 112 employed in the assembly with the outer surface on each side exposed.

The wear plate 112 and supports 118 are manufactured from steel or other metals, like cast iron. In other embodiments the wear plate 112 and supports 118 may be made from other wear resistant materials such as other metals, metal alloys, or ceramics.

While the supports 118 are depicted in a cylindrical form such as steel bars or pillars, it should be apparent that the supports 118 may have other forms, like balls, including a form that allows for the formation of passages into the piston 108 during the casting process for allowing a cooling air flow therethrough if desired.

In manufacturing piston 108, the wear plates 112 and supports 118 are positioned within a mold having a cavity shaped in the form of the piston 108. Molten aluminum is poured into the mold and flows around the supports 118 which become surrounded by the aluminum that hardens to form a strong mechanical bond with the wear plates 112 and supports 118. The wear plates 118 are positioned within the cavity of the mold in a manner that leaves the outer wear surface of each wear plate 112 exposed for the flanges 113, 114 so that they are not covered with aluminum. The casting process may include providing for cooling passages 130 in the piston 108. Since the piston 108 is now made from a lighter weight material than that of the previous ductile iron pistons, this advantageously allows the clutch brake assembly to benefit with a faster stop and a smaller stop angle.

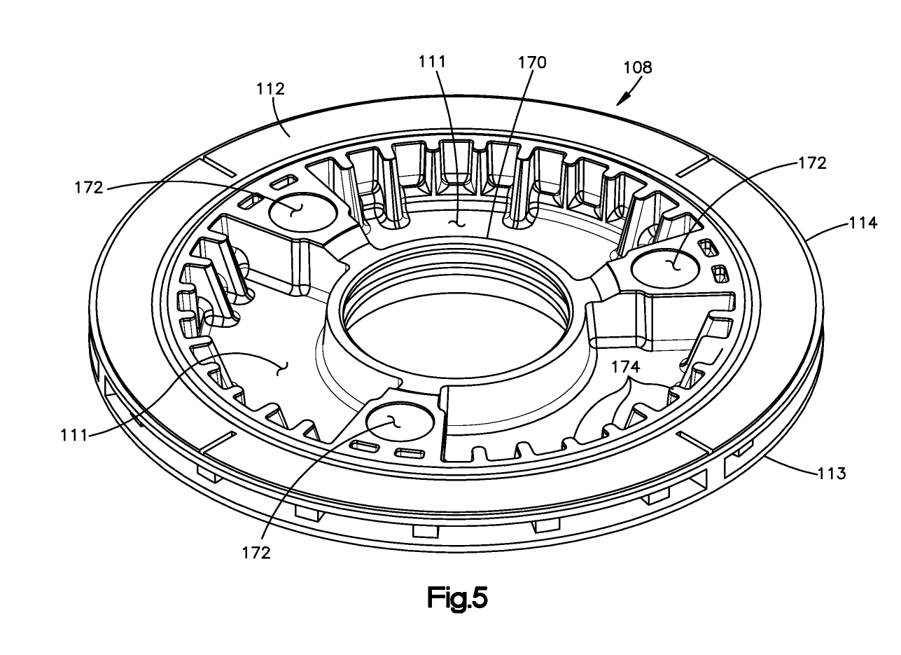

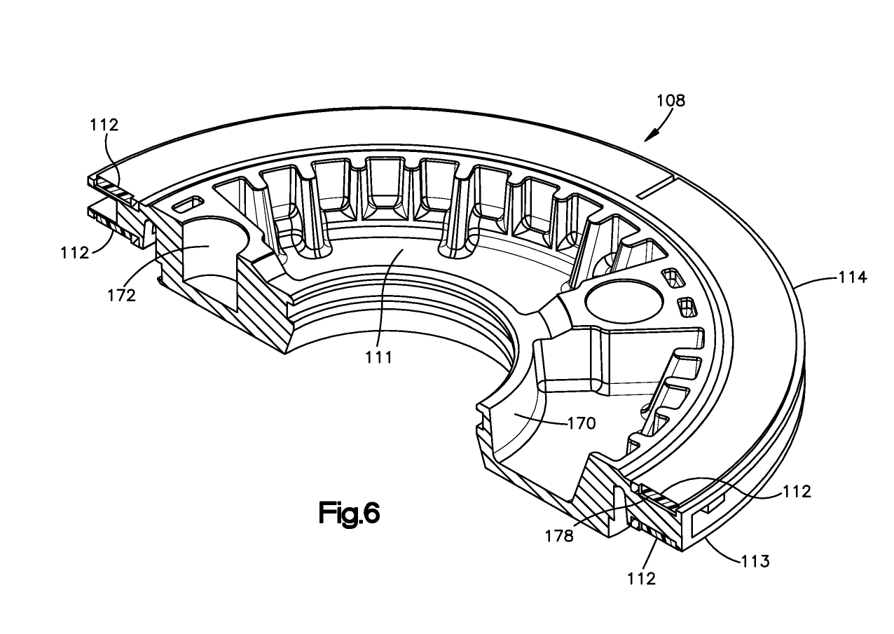

Turning now to FIG. 5, an exemplary piston 108 is depicted in an elevated perspective view. A hub portion 170 is fairly centrally located within piston 108 and is structurally supported with connections to the cylindrical chambers 172. Opening 176 in hub portion 170 has a diameter greater than the central portion 72 of hub 50 to allow it to be received and supported thereon. Piston 108 may further include ribs 174 around an inner circumference adjacent the wear plates 112 for providing support and dissipation of generated heat. The wear surface of wear plates 112 may extend outward to the annular flanges 113, 114 of piston 108 and inwardly to an extent for contact with the friction surfaces on clutch disc 62 and brake disc 60. The annular variable volume spring chamber 111 receives and provides support for one end of springs 138. FIG. 6 in partial sectional view more clearly shows the wear plates 112 cast within piston 108 and the annular spring chamber 111 and cylindrical chambers 172. In FIG. 6, in one embodiment the wear plates 112 are retained within channels 178 in the annular flanges 113, 114 of piston 108. The wear plates 112 extend out from the channels 178 to provide the wear surface necessary for engagement and disengagement of the clutch brake assembly.

The exemplary embodiments have been described with reference to the present practice. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

I claim:

1. An improved piston for a clutch brake assembly, comprising:
an annular wear plate made from a first selected material having wear resistance, the annular wear plate having a circular central opening therethrough; the annular wear plate having a wear surface defined by an outer area between an inner circumference of the first annular wear plate around the circular central opening extending to an outer circumference of the first annular wear plate;
a plurality of supports disposed on the annular wear plate; and
a cast body of a second light weight material formed around the plurality of supports and securing the annular wear plate, the cast body having a circular central opening smaller in diameter than the circular central opening of the annular wear plate, the cast body further having an annular flange containing the wear surface of the annular wear plate.

2. The improved piston as recited in claim 1, further comprising a second annular wear plate made from a first selected material having wear resistance, the second annular wear plate having a circular central opening therethrough, the second annular wear plate having a wear surface defined by an area between an inner circumference of the second annular web plate around the circular central opening extending to an outer circumference of the second annular wear plate, the second annular wear plate being positioned on top of the plurality of supports above the first annular wear plate, and the cast body formed around the plurality of supports and the first and second annular wear plates, the cast body including an annular flange containing the wear surfaces of the first and second annular wear plates.

3. An improved piston as recited in claim 1, wherein said cast body is made of an aluminum material.

4. An improved piston as recited in claim 1, wherein said annular wear plate and plurality of supports are constructed of steel material.

5. An improved piston as recited in claim 2, wherein said first selected material is a member selected from the group consisting of steel, iron, ceramic material, and metal alloys.

6. An improved piston as recited in claim 2, wherein said second selected material is a member selected from the group consisting of aluminum and an aluminum alloy.

7. An improved piston as recited in claim 2, wherein each of said plurality of supports have a cylindrical form.

8. An improved piston as recited in claim 1, wherein said cast body includes a plurality of cooling flow passages.

9. An apparatus for transmitting force to rotate a shaft and for transmitting force to retain the shaft against rotation, said apparatus comprising a base member having a central opening which receives the shaft, a clutch surface which is disposed adjacent to said base member and is movable relative to said base member, said clutch surface being connectable with a source of driving force to be transmitted to the shaft, a brake surface which is disposed adjacent to said base member and is movable relative to said base member, said brake surface being connectable with a stationary member, a piston which is connected with said base member and is movable in first and second directions relative to said base member, said piston being movable in the first direction under the influence of fluid pressure applied to said piston from a variable volume annular fluid chamber to press a first wear surface against said clutch surface to transmit force between said clutch surface and said base member, said piston being movable in the second direction to press a second wear surface against said brake surface to transmit force between said brake surface and said base member, said piston being a cast assembly having an aluminum cast body formed around a plurality of supports and securing a first and second wear plate made from a steel material, said cast body having an annular flange containing wear surfaces from said first and second wear plates, a plurality of force transmission members which extend between said piston and said base member and transmit force between said piston and said base member, a plurality of springs which urge said piston to move in one of said first and second directions relative to said base member, and a plurality of spaced apart spring retainers disposed between said base member and said piston, each of said spring retainers having a base portion and a plurality of projecting portions extending from said base portion, each of said springs being telescopically disposed on one of said projecting portions of said spring retainers to locate said springs relative to said base member, each of said force transmitting members being disposed between adjacent spring retainers of said plurality of spring retainers.

10. An apparatus as set forth in claim 9 wherein said plurality of projecting portions extending from said base portion of each of said spring retainers includes a first series of projections which are disposed in an arcuate inner array having a first radius of curvature and a second series of projections which are disposed in an arcuate outer array having a second radius of curvature which is larger than said first radius of curvature.

11. An apparatus as set forth in claim 9 further including a cover member which is fixedly connected with said base member, said piston being disposed between said base and cover members, said cover member having a plurality of air flow passages which are connected in fluid communication with air flow passages in said piston.
